(19) United States
(12) Patent Application Publication
(10) Pub. No.: US 2015/0154722 A1
(43) Pub. Date: Jun. 4, 2015

(54) Crime Deterrence Using Smartphone Signatures

(71) Applicants: Sounil Yu, Reston, VA (US); Steven Sounyoung Yu, Rockville, MD (US)

(72) Inventors: Sounil Yu, Reston, VA (US); Steven Sounyoung Yu, Rockville, MD (US)

(21) Appl. No.: 14/556,145

(22) Filed: Nov. 29, 2014

Related U.S. Application Data
(60) Provisional application No. 61/910,410, filed on Dec. 1, 2013.

(51) Int. Cl. G06Q 50/26; H04L 29/06; H04W 4/00

(52) U.S. Cl. CPC G06Q 50/265; H04W 4/008; H04L 63/30

(57) ABSTRACT

A method and system of deterring crime by analyzing short-range signals broadcast by mobile wireless personal communication devices. Business places have sensors that are used to detect the short-range broadcast signals. The device signatures are identified by the short-range broadcast signals. When there is a crime event at the business place, a suspect device signature is identified.

### CROSS-REFERENCES

This application claims the benefit of U.S. Provisional Application Ser. No. 61/910,410 (filed 1 Dec. 2013), which is incorporated by reference herein.

### TECHNICAL FIELD

The present invention relates to analyzing short-range radio signals broadcast by mobile wireless personal communication devices to identify device signatures.

### BACKGROUND

With the widespread possession of smartphones, we believe that criminals will often carry their smartphones with them when they are committing criminal acts. Moreover, many criminals are often repeat offenders. For example, bank robbers will often commit serial bank robberies in a short period of time. Observing that criminals may behave in this manner, we have developed an idea for deterring further crimes by the criminal perpetrator by detecting mobile communication devices carried by the perpetrator.

### SUMMARY

Our invention relates to analyzing short-range signals broadcast by mobile wireless personal communication devices for the purpose of deterring criminal activity. In one embodiment, our invention can be characterized as a method of deterring crime at a business place. The method comprises, at a first business place, detecting short-range radio signals broadcast by mobile wireless personal communication devices that are located in the vicinity. The method further comprises recognizing device signatures from the broadcast signals. In response to a crime event at the first business place, the method further comprises identifying a suspect device signature among the set of device signatures recognized, the suspect device signature being associated with the crime event.

At a second business place, the method further comprises detecting short-range radio signals broadcast by mobile wireless personal communication devices that are located in the vicinity and recognizing device signatures from the broadcast signals. If any of the recognized device signatures is determined to be a suspect device signature, then the perception of security at the second business place is enhanced.

The first business place and/or the second business place may be located in a stand-alone building. The first business place and the second business place may operate the same type of business. The first business place and the second business place may both be retail banks The step of identifying a suspect device signature may comprise eliminating innocent device signatures from the set of device signatures recognized. The innocent device signatures may include those of personnel and/or customers present in the first business place at the time of the crime event. The step of identifying the suspect device signature may comprise analyzing the changes in the set of device signatures detected at the first business place around the time of the crime event. The step of identifying the suspect device signature may comprise selecting a device signature that was present before and during the time of the crime event, but departed from the vicinity immediately after the crime event (e.g. a time that is within 2 minutes after the crime event). The first business place and the second business place may be the same or different.

Criminals often commit further crimes within geographic proximity of their previous crimes. As such, in some embodiments, for more than 75% of the cases of a suspect device signature being detected at the second business place, the location of the first business place where the suspect device signature was identified is less than 90 miles away (straight line distance) from the second business place. Criminals often commit their criminal activity clustered in time (e.g. in spurts of activity). As such, in some embodiments, for more than 75% of the cases of a suspect device signature being detected at the second business place, the date of the crime associated with the suspect device signature at the first business place is within the prior three months of detection at the second business place.

In another embodiment, our invention is a method of deterring crime at a business place, comprising: (a) at the business place, detecting short-range radio signals broadcast by mobile wireless personal communication devices that are located in the vicinity; (b) recognizing device signatures from the broadcast signals; (c) in response to a crime event committed by a perpetrator at the business place, identifying a suspect device signature among the set of device signatures recognized; (d) entering the suspect device signature into a database that associates the suspect device signature with the crime event.

In another embodiment, our invention is a method of deterring crime at a business place, comprising: (a) having suspect device signatures that are associated with previous crime events; (b) at the business place, detecting short-range radio signals broadcast by mobile wireless personal communication devices that are located in the vicinity; (c) recognizing device signatures from the broadcast signals; (d) determining if any of the recognized device signatures is a suspect device signature; (e) if so, then enhancing the perception of security at the business place.

In another embodiment, our invention is a crime deterrent system comprising: (a) a first sensor located inside a first business place, the first sensor detecting short-range radio signals broadcast by mobile wireless personal communication devices that are located in the vicinity; (b) a first computer system that is in communication with the first sensor and recognizes device signatures from the broadcast signals; (c) a second sensor located inside a second business place, the second sensor detecting short-range radio signals broadcast by mobile wireless personal communication devices that are located in the vicinity; (d) a second computer system that is in communication with the second sensor and recognizes device signatures from the broadcast signals; (e) wherein the second computer system stores a suspect device signature associated with a crime event that occurred at the first business place and determines if any of the device signatures detected at the second business place is a suspect device signature.

### BRIEF DESCRIPTION OF THE DRAWINGS

FIG. 1 depicts a scene at the fictional Tysons Corner Bank equipped with a sensor that reads signals broadcast by the patrons' smartphones. The device ID signatures are shown on the right side of the figure.

FIG. 2 depicts an event subsequent to FIG. 1 where a bank robber is holding up the bank tellers.

FIG. 3 depicts the scene after the bank robber leaves the bank. As shown here, after he leaves the bank and is out-of-range, his device signature “B2b” is no longer detected.

FIG. 4 depicts a subsequent scene at the fictional Silver Spring Bank where the same bank robber intends to commit another hold-up robbery. The Silver Spring Bank is equipped with a sensor that reads signals broadcast by the patrons' smartphones.

FIG. 5 shows the sensor registering the bank robber's smartphone device signature “B2b.” In response, security guards are deployed onto the floor.

FIG. 6 shows the perpetrator leaving the Silver Spring Bank after changing his mind about robbing the bank.

### DETAILED DESCRIPTION

1. Glossary. “Business place” means a place of business that is open to the general public for the sale of goods or services. Examples include retail banks, retail stores, restaurants, places of entertainment, personal service providers (e.g. nail salons, doctor's office, etc.), gathering or meeting places (e.g. convention centers, hotels, etc.). “Mobile wireless personal communication devices” means portable electronic devices that are capable of wireless communications. Examples include smartphones, smartwatches, mobile phones, tablet computers, notebook computers, or other personal electronic devices used for wireless communication (e.g. via voice, text, video, Internet, etc.). “Short-range radio signals” means radio signals having a range of less than 250 meters. Examples include Wi-Fi, Bluetooth, and ZigBee signals. “Vicinity” means a distance in relation to the range of these short-range radio signals. For example, if the short-range signal has a range of 100 meters, then the vicinity would be within 100 meters. “Identifying data” means one or more pieces of information contained in signals broadcast by the device that can be used to identify a particular device. “Device signature” means the identifying data that is associated with a particular device. Preferably, the device signature is unique, but that is not required. “Suspect device signature” means a device signature that has been associated with a crime event.

2. Introduction. Our invention is used in business places that are open to the general public for the sale of goods or services. Examples of such business places include retail banks, retail stores, restaurants, places of entertainment, personal service providers, gathering or meeting places, etc. Our invention can be applied for various types of crimes that are committed on the premises of a business place, such as theft (e.g. bank robbery, shoplifting, etc.), assault, destruction of property (e.g. vandalism), etc.

3. Sensor. The business place has a sensor (e.g. radio receiver) that detects short-range radio signals broadcasted by mobile wireless personal communication devices, such as smartphones, smartwatches, mobile phones, tablet computers, notebook computers, or other personal electronic devices used for wireless communication (e.g. via voice, text, video, Internet, etc.). Because our invention is concerned with perpetrators (and by implication, their mobile communication devices) who are physically present in the vicinity of the business place (e.g. within or on the business premises), the signals being detected are those with relatively shorter range, in particular, those having a range of less than 250 meters; and in some cases, less than 150 meters range. Examples of such short-range radio signals broadcast by mobile communication devices include Wi-Fi and Bluetooth signals. A single device may have multiple types of transceivers that broadcast different types of short-range signals (e.g. both a Wi-Fi and Bluetooth transceiver) . As used herein, the term “vicinity” is in relation to the range of these short-range radio signals. For example, if the short-range signal has a range of 100 meters, then the vicinity would be within 100 meters. In some embodiments, our invention may use more precise positioning of the detected device (e.g. by triangulation or other positioning technique using two or more sensors placed in different locations).

In some cases, the business place is located in a stand-alone building, such as a bank in its own building. For example, the business place can be located on a free-standing commercial pad site (e.g. a bank pad). Our invention can work well in business places that are located in stand-alone buildings because this reduces the likelihood of detecting signals from adjacent business places. However, the business place does not have to be in a stand-alone building. For example, the business place may be a jewelry store inside a mall or shopping center. The business place does not have to be separately enclosed. For example, the business place may be a bank located in a corner section of a grocery or department store.

In some embodiments, the sensor is located at a position that is at least 15 meters away from the physical boundary of an adjacent business premise; in some cases, at least 25 meters away; and in some cases, at least 40 meters away. Locating the sensor farther away from the adjacent business premise may help to reduce the amount of non-relevant signals broadcast from other mobile wireless personal communication devices that are not on the premises of the business place (e.g. from patrons shopping at the store next door).

4. Device Signature. The signals broadcast by mobile communication devices can contain various types of information that can be used, individually or in combination, in identifying a particular device. Examples of such identifying information include the device's MAC (media access control) address, Bluetooth address, known Wi-Fi network names (SSID, service set identifier), signal strength, device brand/manufacturer, device model number, etc.

The identifying data may be a single piece of information or multiple pieces of information in combination (e.g. different types of identifying data or a set of a single type of identifying data). The identifying data associated with a device is referred to herein as the device “signature.” The device signature can be unique, but that is not required. For the purposes of our invention, the device signature need only be reasonably distinct as explained further below.

In some embodiments, the device signature is taken from the requests broadcast by the mobile communication device while seeking Wi-Fi networks. For example, while scanning for Wi-Fi networks in the vicinity, the mobile communication device may broadcast information about its own address (e.g. MAC address for Wi-Fi or Bluetooth address for Bluetooth). This device address may be used as the device signature.

In another example, while scanning for Wi-Fi networks in the vicinity, the mobile communication device may broadcast information about Wi-Fi networks that are already known to the device, such as the network names (SSID) or MAC addresses of such Wi-Fi networks. Such devices may maintain a list of previously accessed Wi-Fi networks. For example, the following may be a set of Wi-Fi network SSIDs that are remembered by someone's smartphone and broadcast out while scanning for Wi-Fi networks in the area. This list of Wi-Fi network SSIDs may be used as the device signature.

Example set of Wi-Fi SSIDs

Smith_Home_Network
312_MSB
Guest_Hotel_CA
LAX_Airport
Matrix_Corp
Metro-Rail
K_Street_Cafe

5. Crime Event. When a crime is committed at a business place (e.g. a bank robbery), our invention realizes that the perpetrators may have been carrying mobile communication devices with them. Our invention involves identifying their devices (i.e. the suspect device signatures) to deter further crime by the perpetrators. Since there may have been multiple mobile communication devices in the vicinity (and multiple device signatures detected) at the business place, the suspect device signatures may need to be isolated from the set of device signatures detected.

Thus, our invention involves isolating one or suspect device signatures (associated with one or more perpetrators) from the set of device signatures that were detected. Our invention encompasses the various types of algorithms that can be used to isolate the suspect device signatures. In some embodiments, isolating the suspect device signatures involves narrowing down the set of possible candidates. For example, this may involve ruling-out the device signatures of mobile communication devices carried by employee/personnel, ruling-out the device signatures for the mobile communication devices carried by customers or passerby who were also present at the time, and/or ruling-out the device signatures of other devices that are not carried by the perpetrator (i.e. innocent device signatures).

In some embodiments, isolating the suspect device signatures involves analyzing the changes in the set of device signatures detected around the time of the crime event. For example, we can select device signatures that were present before and during the time of the crime event, but left the vicinity immediately after the crime event (e.g. within 2 minutes after the crime event). The time window for making this analysis can vary according to particular situations. Examples of time windows which could be suitable include time windows that are encompassed by [10 minutes before to 5 minutes after the crime event] or [5 minutes before to 2 minutes after the crime event].

In some cases, it may not be possible to narrow down the suspected device to a single one. However, the method is still operative because it does not require having to specifically identify, accuse, and/or take any intervention against any particular individual person. Because it operates to deter crime without targeting any specific individual, the device identification does not have to be made with absolute certainty. Thus, the device signature does not necessarily have to be unique. The level of distinctiveness (and probability of true positives vs. false positives) can be adjusted according to varying factors such as tolerance for false alarms, cost of security presence, local population size, etc.

6. Crime Deterrence. At a later time, when the perpetrator carrying the same mobile device enters the same business place or another business place equipped in the manner of our invention, the suspect device signature can be detected again. The perpetrator may intend to commit another crime. In response to the suspect device being detected, the perception of security at the business place is enhanced. This can be achieved by any visible or audible action that causes the perpetrator to become flustered, unnerved, or otherwise disrupt his intent to commit a crime, without actually specifically targeting the perpetrator. This action may also be performed in a way that avoids or minimizes alarming customers at the business place.

Examples of enhancing the perception of security include deploying security guards onto the floor, increasing the number of security guards, increasing the attention of the security guards, increasing the visibility of the security guards (e.g. moving them to the middle of the floor), increasing the mobility of the security guards (e.g. having them pace back-and-forth in an authoritative manner), moving the security guards closer to the bank teller windows, increasing the visibility of the security cameras (e.g. by activating motion, flashing lights, etc.), making the ambient lighting brighter, a bright flash of light, moving tellers to a more secure location, making a loud public announcement (e.g. “For quicker service, please use our ATM outside.”). Flustered by these actions that enhance the perception of security, the perpetrator may reconsider committing the crime and leave the premises.

Note that our invention does not require personal identification of the perpetrator, nor does it require actual intent to commit a crime. If the perpetrator does not intend to commit a crime at the business place, then he may continue going about his business without interference. But if he did intend to commit a crime, then the enhanced perception of security may cause him to reconsider.

7. Operational Configurations. The physical and/or functional components of the our invention may be distributed, centralized, or arranged in any suitable manner. Communications between the different physical and/or functional component may be performed in any suitable way. Moreover, our invention encompasses all the various ways in which the operating work may be divided among different physical and/or functional components. For example, the work in collecting, processing, and monitoring of the data received from the sensors at different locations may be divided between the individual locations and a central site.

Our invention also encompasses all the various ways in which different business entities may be involved. For example, a retail banking chain may operate our invention for its branch locations. The operations may be coordinated from a central or regional site. When a suspect device signature is detected, then the affected branch location is alerted. This service may be extended to other retail banking chains, allowing them to participate in the network.

In another example, the operations may be performed by an independent service provider for participating retail banking chains. In such cases, a suspect device signature initially identified at a branch location of one banking chain can be detected at a branch location of a different banking chain, which is then alerted. Thus, the business place where the suspect device signature is initially identified (i.e. where the crime is committed) may not necessarily be part of the same business entity as the business place where the suspect device signature is subsequently detected.

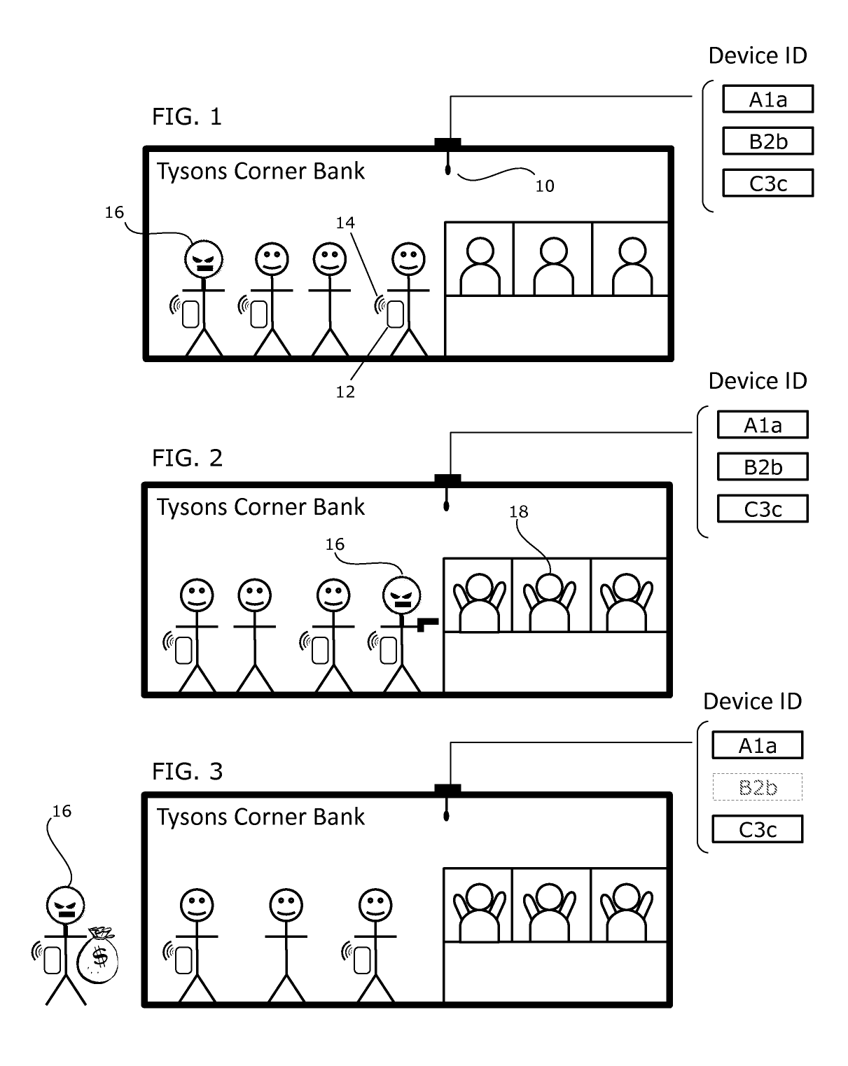

8. Example. An example of our invention is shown in FIGS. 1-6. FIG. 1 depicts the scene at the Tysons Corner Bank, where there are four patrons inside the bank, three of whom have smartphones 12. Their smartphones 12 broadcast their MAC address when searching for Wi-Fi networks. These broadcast signals 14 are read by the sensor 10 in the bank and are shown in FIG. 1 as device ID signatures A1a, B2b, C3c (fictional addresses). These MAC addresses are used as the device signature to identify the smartphones 12, but the device signature does not identify the individual person carrying the smartphones.

As shown in FIG. 2, one of the patrons is a bank robber 16 who holds up the bank tellers 18. As shown in FIG. 3, after collecting the money, the bank robber 16 leaves the bank. When he leaves, his smartphone is out of range and his device signature “B2b” is no longer detected. As such, the device ID “B2b” is identified as the suspect device signature.

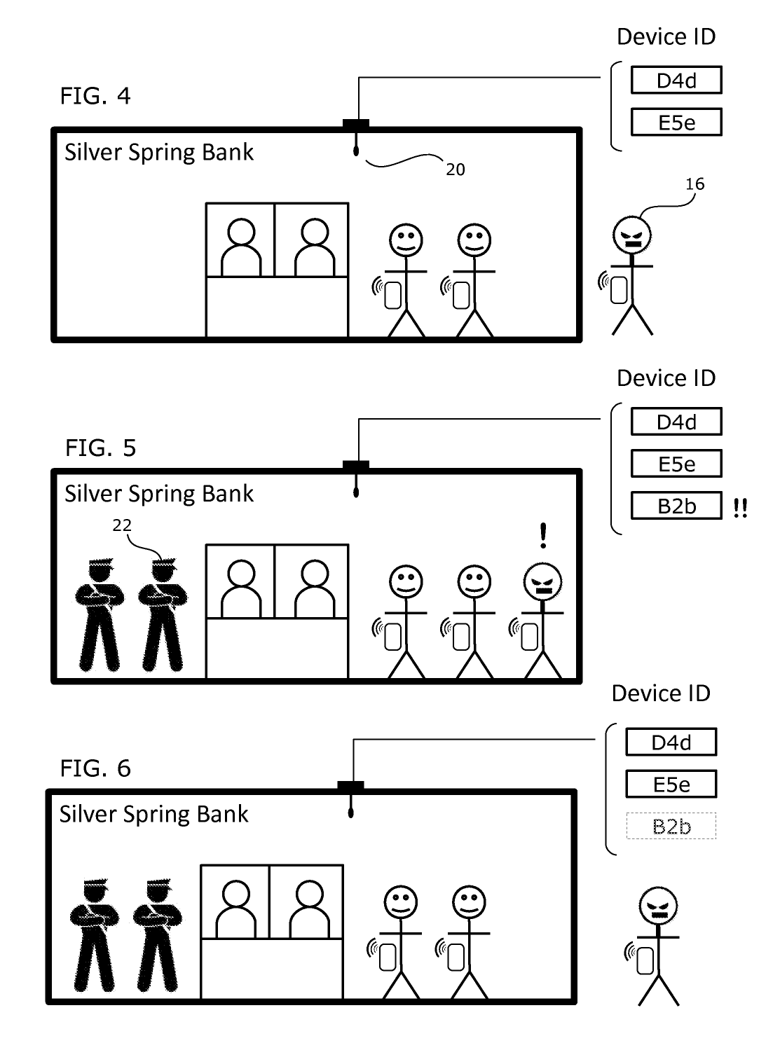

Two days later, as shown in FIG. 4, the same bank robber 16 approaches the Silver Spring Bank with the intent to commit another hold-up robbery. He is carrying the same smartphone as when he robbed the Tysons Corner Bank. As shown in FIG. 5, upon entering the bank, the sensor 20 registers his smartphone device signature “B2b.” Silver Spring Bank is a participating bank and is alerted that a suspect device has entered the premises. In response, security guards 22 are deployed onto the floor. As shown in FIG. 6, the perpetrator sees the security guards 22 and changes his mind about committing the bank robbery. Thus, the system has successfully deterred the bank robbery at Silver Spring Bank.

We claim:

1. A crime deterrent system comprising:
a first sensor located inside a first business place, the first sensor detecting short-range radio signals broadcast by mobile wireless personal communication devices that are located in the vicinity;
a first computer system that is in communication with the first sensor and recognizes device signatures from the broadcast signals;
a second sensor located inside a second business place, the second sensor detecting short-range radio signals broadcast by mobile wireless personal communication devices that are located in the vicinity;
a second computer system that is in communication with the second sensor and recognizes device signatures from the broadcast signals;
wherein the second computer system stores a suspect device signature associated with a crime event that occurred at the first business place and determines if any of the device signatures detected at the second business place is a suspect device signature.

2. The system of claim 1, wherein the first computer system is the same as the second computer system, or wherein the first computer system is in communication with the second computer system.

3. The system of claim 1, wherein the first business place and the second business place operate the same type of business.

4. The system of claim 3, wherein the first business place and the second business place are both retail banks

5. The system of claim 3, wherein the first business place and the second business place are both retail stores.

6. The system of claim 1, wherein the first business place, the second business place, or both are located in a stand-alone building.

7. The system of claim 6, wherein the first business place and the second business place operate the same type of business.

8. The system of claim 7, wherein the first business place and the second business place are both retail banks

9. The system of claim 7, wherein the first business place and the second business place are both retail stores.

10. The system of claim 1, wherein the first and second sensors detect Wi-Fi signals.

11. The system of claim 1, wherein the first and second sensors detect Bluetooth signals.

12. The system of claim 1, wherein the device signature comprises the device's MAC (media access control) or Bluetooth address.

13. The system of claim 1, wherein the device signature comprises a set of Wi-Fi network names or MAC addresses that are known by the device. Bank-R1

14. The system of claim 1, wherein the first business place and the second business place are both part of the same business entity.

15. The system of claim 14, wherein the first business place and the second business place operate the same type of business.

16. The system of claim 1, wherein the first sensor inside the first business place is located at a position that is at least 15 meters away from the physical boundary of an adjacent business premise, and the second sensor inside the second business place is located at a position that is at least 15 meters away from the physical boundary of an adjacent business premise.

17. The system of claim 16, wherein the first business place and the second business place operate the same type of business.

18. The system of claim 17, wherein the first business place and the second business place are both retail banks

19. The system of claim 17, wherein the first business place and the second business place are both retail stores.

20. The system of claim 17, wherein the first business place, the second business place, or both are located in a stand-alone building.
